(19) United States
(12) Patent Application Publication
(10) Pub. No.: US 2009/0193392 A1
(43) Pub. Date: Jul. 30, 2009

(54) DYNAMIC INTERMEDIATE LANGUAGE MODIFICATION AND REPLACEMENT

(76) Inventors: Michael David Downen, Sammamish, WA (US); Aidan T. Hughes, Bellevue, WA (US); Jonathan W. Keljo, Seattle, WA (US); Simon J. Hall, Seattle, WA (US); Xia Li, Sammamish, WA (US); Raja Krishnaswarny, Redmond, WA (US); Atsushi Kanamori, Redmond, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(21) Appl. No.: 11/963,189

(22) Filed: Jan. 29, 2008

(51) Int. Cl. G06F 9/44

(52) U.S. Cl. 717/106; 717/110

(57) ABSTRACT

Embodiments are directed to providing intermediate language (IL) code on a per-method basis for at least one method of a binary. In one embodiment, a computer system selects a method from among various methods included in a binary file, where the methods are configured to perform various intended functions for an application. The computer system appends a descriptive marker to the selected method indicating how to obtain IL code that is to be included in the body of the selected method, receives a command to execute the selected method, and refers to the appended descriptive marker to generate an IL code request based on the indication in the descriptive marker. The computer system submits the generated IL code request to one or more IL code providers to request IL code for the selected method, receives the requested IL code for the selected method and inserts the IL code into the body of the selected method.

### BACKGROUND

As computer use has proliferated in today's society, the number of methods and systems for developing software applications to run on these computers has also increased. Software applications may be used to perform a wide variety of tasks based on the design of the application being used. Software applications typically include a number of individual files designed to work together to create some type of desirable end result. In order to write such software applications, software developers typically decide on a programming language to use for that application. Many programming languages are in use today and, as a result, many software applications are written in different languages. These languages are often incompatible with each other, not a few of which use different syntax, different compiling methods and other, different code elements.

To simplify the integration and use of multiple programming languages in their various implementations, managed code has been introduced to provide a platform in which these various applications can interact. Managed code, however, has introduced new problems and inefficiencies for developers of applications that run within such managed frameworks. For example, intermediate language (IL) elements are often added to (or compiled with) source code to supplement a file assembly. These IL elements provide information that may supplement functionality of the file and/or make the file compatible with other files within the framework.

In some situations, IL elements may be provided for a file at runtime, rather than using statically generated IL elements. Typically, a common language runtime (CLR) used by the managed framework uses a hook to provide the IL elements at runtime. The hook, however, applies to all the methods within a program process and cannot be individually applied to given methods.

### BRIEF SUMMARY

Embodiments described herein are directed to providing intermediate language (IL) code on a per-method basis for at least one method of a binary. In one embodiment, a computer system selects a method from among various methods included in a binary file, where the methods are configured to perform various intended functions for an application. The computer system appends a descriptive marker to the selected method indicating how to obtain IL code that is to be included in the body of the selected method, receives a command to execute the selected method, and refers to the appended descriptive marker to generate an IL code request based on the indication in the descriptive marker. The computer system submits the generated IL code request to one or more IL code providers to request IL code for the selected method, receives the requested IL code for the selected method and inserts the IL code into the body of the selected method.

Other embodiments are directed to modifying intermediate language (IL) code on a per-method basis for at least one method of the assembly. A computer system receives a request indicating an intention to modify IL code in the body of a method in an assembly. The computer system selects a method from among one or more methods included in the compiled assembly where the methods are configured to perform one or more intended functions for an application. The computer system refers to security properties in a descriptive marker associated with the method indicating those entities that are authorized to modify the selected method's IL code, determines that the received request was received from an entity that is not authorized to modify the selected method's IL code based on the security properties in the descriptive marker and prevents the user from modifying the IL code based on the determination that the user is not authorized to modify the selected method's IL code.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a computer architecture in which embodiments of the present invention may operate including providing intermediate language (IL) code on a per-method basis for at least one method of the binary.

FIG. 2 illustrates a flowchart of an example method for providing intermediate language (IL) code on a per-method basis for at least one method of the binary.

FIG. 3 illustrates a computer architecture in which embodiments of the present invention may operate including modifying intermediate language (IL) code on a per-method basis for at least one method of the assembly.

FIG. 4 illustrates a flowchart of an example method for modifying intermediate language (IL) code on a per-method basis for at least one method of the assembly.

### DETAILED DESCRIPTION

Embodiments described herein are directed to providing intermediate language (IL) code on a per-method basis for at least one method of a binary. In one embodiment, a computer system selects a method from among various methods included in a binary file, where the methods are configured to perform various intended functions for an application. The computer system appends a descriptive marker to the selected method indicating how to obtain IL code that is to be included in the body of the selected method, receives a command to execute the selected method, and refers to the appended descriptive marker to generate an IL code request based on the indication in the descriptive marker. The computer system submits the generated IL code request to one or more IL code providers to request IL code for the selected method, receives the requested IL code for the selected method and inserts the IL code into the body of the selected method.

Other embodiments are directed to modifying intermediate language (IL) code on a per-method basis for at least one method of the assembly. A computer system receives a request indicating an intention to modify IL code in the body of a method in an assembly. The computer system selects a method from among one or more methods included in the compiled assembly where the methods are configured to perform one or more intended functions for an application. The computer system refers to security properties in a descriptive marker associated with the method indicating those entities that are authorized to modify the selected method's IL code, determines that the received request was received from an entity that is not authorized to modify the selected method's IL code based on the security properties in the descriptive marker and prevents the user from modifying the IL code based on the determination that the user is not authorized to modify the selected method's IL code.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical storage media and transmission media.

Physical storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry or transport desired program code means in the form of computer-executable instructions or data structures and which can be accessed by a general purpose or special purpose computer. Combinations of the above should also be included within the scope of computer-readable media.

However, it should be understood, that upon reaching various computer system components, program code means in the form of computer-executable instructions or data structures can be transferred automatically from transmission media to physical storage media. For example, computer-executable instructions or data structures received over a network or data link can be buffered in RAM within a network interface card, and then eventually transferred to computer system RAM and/or to less volatile physical storage media at a computer system. Thus, it should be understood that physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

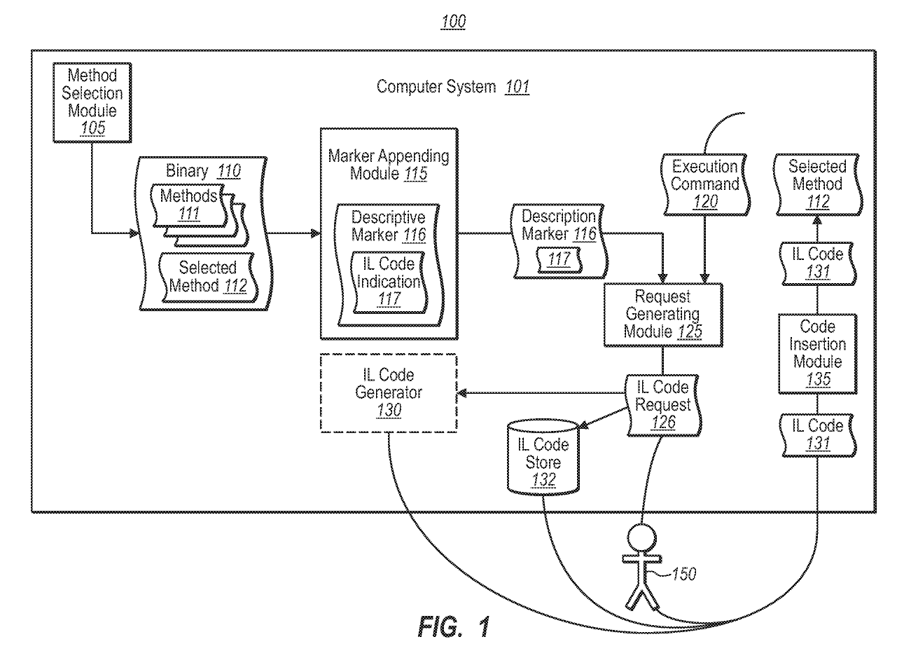

FIG. 1 illustrates a computer architecture 100 in which the principles of the present invention may be employed. Computer architecture 100 includes computer system 101. In some embodiments, computer system 101 includes method selection module 105. Method selection module 105 may be configured to select a method from among methods 111 in binary 110. Selected method 112 may be selected by computer system 101, user 150, or any module within computer system 101. Binary 110 may include any type of software file. In some embodiments, binary 110 includes uncompiled source code with multiple different methods 111. In other cases, binary 110 includes code compiled into an intermediate language (IL). Although IL is used frequently herein to refer to a type of software code that may be generated, modified, replaced or otherwise used, it should be noted that scripts, source code, compiled binaries and other forms of software code may also be used in addition to or in place of IL code. Methods 111 may include classes, objects or other groupings of statements configured to perform a certain function.

Binary 110 may be sent to marker appending module 115 to have a descriptive marker appended to it. For example, descriptive marker 116 with IL code indication may be appended to binary 110, or more specifically, to one of methods 111, in some cases selected method 112. Descriptive markers may be configured to indentify methods for which the IL code of the method's body is to be replaced. Furthermore, descriptive marker 116 may be configured to designate where such replacement IL code is stored and how the code may be retrieved (e.g. in IL code indication 117). This process will be explained in greater detail below.

Descriptive marker 116 may be sent, along with IL code indication 117, to request generating module 125. Request generating module 125 may, upon receiving execution command 120, generate a request for the replacement IL code mentioned above. The request (e.g. IL code request 126) may be generated using IL code indication 117 indicating which method the code is to be used for and where to get the replacement IL code. Execution command 120 may be any type of computer- or user-generated command to execute binary 110. In some embodiments, IL code request 126 may not be generated until receiving execution command 120. In other cases, however, IL code request 126 may be generated in advance of execution command 120 or even without receiving such a command.

IL code request 126 may be sent to all or any of IL code generator 130, IL code store 132 or user 150. IL code generator 130 may be configured to generate IL code 131 based on IL code request 126. IL code indication 117 may indicate the parameters of the IL code that is to be generated. Thus, IL code generator 130 may be configured to generate IL code on-the-fly after receiving IL code request 126, or may generate the code in advance of receiving request 126. IL code store 132 may be any kind of database or other storage mechanism configured to store electronic information. In some cases, IL code store 132 includes IL code 131, which is sent to code insertion module 135 upon receiving IL code request 126. In other cases, IL code request 126 may be sent to user 150 who may either generate or otherwise access IL code 131 for sending to code insertion module 135. Code insertion module 135 may be configured to insert received IL code 131 into the body of selected method 112. In some cases, IL code 131 may entirely replace the method body of selected method 112. In other cases, IL code 131 may supplement the method body of selected method 112.

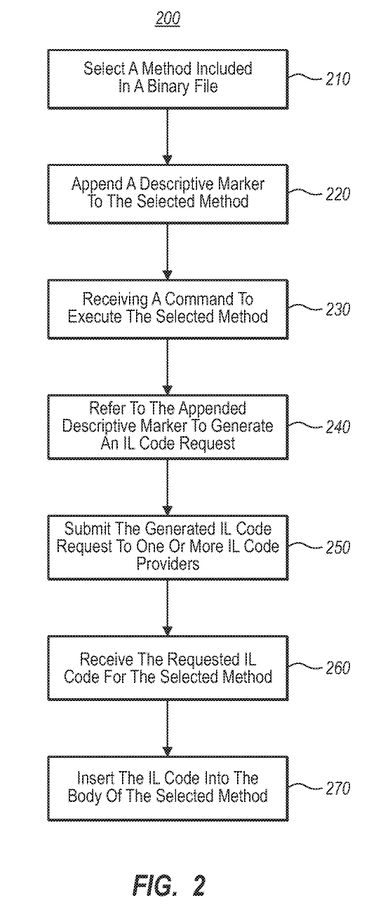

FIG. 2 illustrates a flowchart of a method 200 for providing intermediate language (IL) code on a per-method basis for at least one method of the binary. The method 200 will now be described with frequent reference to the components and data of environment 100.

Method 200 includes an act of selecting a method from among one or more methods included in a binary file, the one or more methods being configured to perform one or more intended functions for an application (act 210). For example, method selection module 105 may select method 112 from among methods 111 included in binary file 110, where methods 111 and 112 are configured to perform one or more intended functions for a software application. Selected method may include in its body a portion of IL code. The IL code may include anything from a single statement to a plurality of statements of varying complexity.

Method 200 includes an act of appending a descriptive marker to the selected method indicating how to obtain IL code that is to be included in the body of the selected method (act 220). For example, marker appending module 115 may append descriptive marker 116 to selected method 112 indicating how to obtain IL code (e.g. IL code 131) that is to be included in the body of selected method 112. In some cases, descriptive marker 116 indicates which entity is to provide the IL code for the selected method using a software hook.

A software hook may be any type of software mechanism used to identify or access a certain portion of desired functionality associated with a software program or method. For example, descriptive marker 116 may include a software hook that identifies where to obtain the IL code that is to replace or supplement existing IL code. Or, descriptive marker 116 may include a software hook that allows an outside user or computer system to access the functionality of the method (e.g. selected method 112). In some cases, a software hook may be configured to return a fully-compiled method body instead of (or in addition to) an IL method body. In other cases, a software hook may be configured to return source code which could be used, for example, in a scripting environment.

In some cases, an interface may be provided that defines at least some of the functionality that a software hook writer is to provide in order to modify the IL code. Thus, such an interface may indicate that in order to modify or generate IL code 131, certain functionality is to be provided in the software hook that enables IL code generation or modification. In some instances, descriptive marker 116 may be a custom attribute. In such cases, the custom attribute may specify which portions of the method body are to be generated or replaced and where to obtain the generated and/or replacement code. Although in FIG. 1, only a single IL code generator is shown, many IL code generators may exist and may be usable to generate IL code 131. A software hook or custom attribute may be used to indicate which IL code generator is to be used to generate IL code 131 for selected method 112. In some embodiments, multiple IL code generators may be used to generate different portions of IL code 131 or for different methods in binary 110 (e.g. methods 111).

It may be advantageous, in some cases, to append multiple descriptive markers to a single selected method. For example, it may be desirable to link multiple descriptive markers together such that one marker references another marker to indicate how to obtain generated and/or replacement IL code for a given method. Thus, descriptive markers may be fully customizable by user 150 and/or computer system 101 and may be linked to each other to extend their functionality.

Method 200 includes an act of receiving a command to execute the selected method (act 230). For example, request generating module 125 may receive execution command 120 to execute selected method 112. Execution command 120 may originate from user 150, computer system 101, or another computer system linked or networked to computer system 101. Execution command 120 may indicate that the any existing IL code in selected method 120 is to be executed. Thus, a system configured to replace or generate different IL code for selected method 112 may interpret execution command 120 as a signal to begin the replacement or code generation.

Method 200 includes an act of referring to the appended descriptive marker to generate an IL code request based on the indication in the descriptive marker (act 240). For example, request generating module 125 may refer to appended descriptive marker 116 to generate IL code request 126 based on IL code indication 117. For instance, IL code indication may indicate that new IL code is to be generated for selected method 112. In that case, request generating module 125 may use IL code indication 117 to know what type or know how to generate the desired IL code for the method. In other cases, request generating module 125 may use IL code indication 117 to know where to send IL code request 126 to obtain IL code 131 that is to be inserted in selected method 112. For example, request generation module 125 may send request 126 to either or both of IL code store 132 and user 150 to indicate that they are to provide IL code 131 to code insertion module 135.

Method 200 includes an act of submitting the generated IL code request to one or more IL code providers to request IL code for the selected method (act 250). For example, request generating module 125 may submit IL code request 126 to IL code providers such as IL code generator 130, IL code store 132, and user 150 to request IL code for selected method 112. Thus, for example, where IL code request 126 includes a request for code generation, the request may be sent to IL code generator 130. In cases where IL code request 126 includes a request to supply IL code 131 from user 150 or IL code store 132, the request may be sent to either or both of user 150 and IL code store 132. In some embodiments, the IL code in IL code store 132 is stored in an encrypted form.

Method 200 includes an act of receiving the requested IL code for the selected method (act 260). For example, code insertion module 135 may receive IL code 131 associated with selected method 112. In some cases, IL code 131 may be received at runtime. In other cases, IL code 131 may be received as part of source compile, at post-processing of the binary file as part of distribution, at deployment or at activation. Thus, for example, IL code that would have been compiled by a just-in-time compiler at runtime may be replaced with received IL code 131, received from any of user 150, IL code generator 130 or IL code store 132. As explained above, received IL code 131 may be used to replace certain portions or all of the IL code in selected method 112's method body, or may be used in conjunction with any existing IL code in selected method 112's method body.

Method 200 also includes an act of inserting the IL code into the body of the selected method (act 270). For example, code insertion module 135 may insert IL code 131 into the body of selected method 112. In some cases, code 131 may supplant any existing code in the method's body. In other cases, code 131 may supplement existing code in method 112's body. IL code 131 may be compiled with binary 110 after the code has been inserted into the method. Thus, IL code may be inserted from a variety of sources during runtime or any time the binary is read.

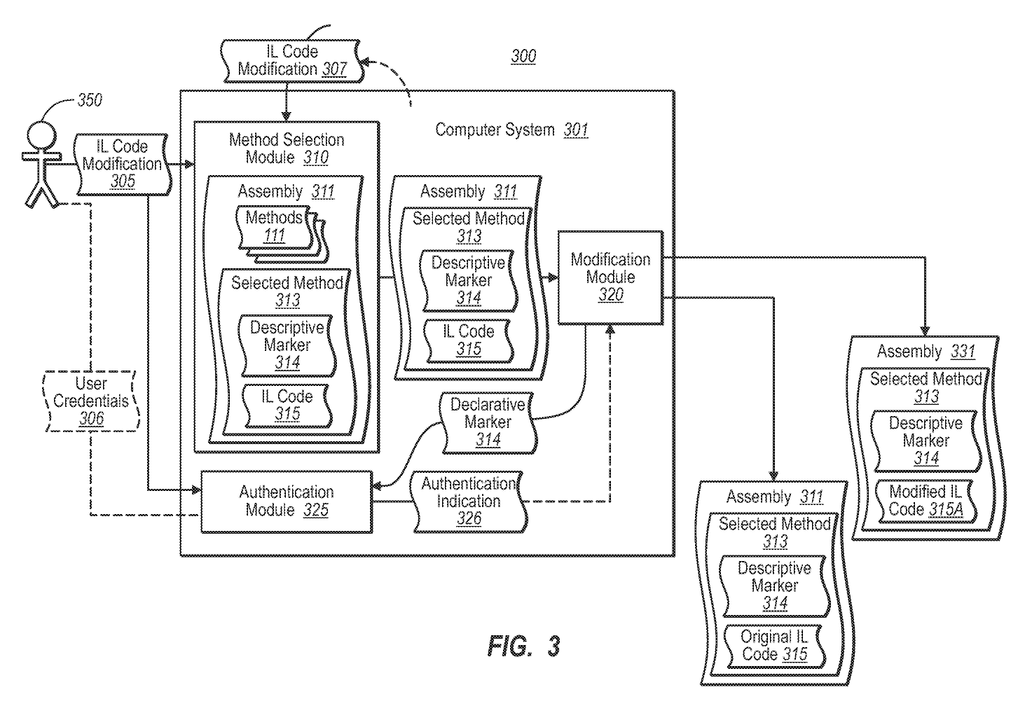

FIG. 3 illustrates a computer architecture 300 in which the principles of the present invention may be employed. Computer architecture 300 includes computer system 301. In some embodiments, computer system 301 includes method selection module 310. Similar to method selection module 105, method selection module 310 may be configured to select a method (e.g. selected method 313) from among a plurality of different methods 111. For example, assembly 311 may include methods 111 and selected method 313 with accompanying descriptive marker 314 and IL code 315. Assembly 311 may be any type of software code and, in some cases, may refer to compiled code. Selected method 313 may include IL code 315 as a portion of or all of its method body.

Descriptive marker 314 may be configured to indicate that selected method 313 is to have its IL code replaced or supplemented from an outside source such as computer user 350 or computer system 301. For example, IL code modification 307 may be received from another computer system, or from computer system 301. IL code modification 307 may be received from a software program within computer system 301 indicating that an existing method marker has been reached that has requested verification of the IL provider. In some embodiments, method selection module 310 may be configured to receive IL code modifications from a variety of entities. Thus, although computer user 350 is frequently used as the source of an IL code modification herein, other entities may also (additionally or alternatively) provide such modifications. Descriptive marker 314 may be appended to selected method 313 in the same or a similar manner to that described above.

Method selection module 310 may be configured to send assembly 311 including selected method 313, descriptive marker 314 and IL code 315 to modification module 320. In some embodiments, modification module 320 may be configured to receive assembly 311, along with authentication indication, and modify IL code 315 based on user 350's authentication status. In some cases, if user 350's credentials 306 are authorized by authorization module 325, modification module 320 will modify IL code 315, resulting in assembly 331 with selected method 313, descriptive marker 314 and modified IL code 315A. In other cases, if user 350's credentials 306 are not authorized by authorization module 325, modification module 320 will not modify IL code 315, resulting in assembly 311 with selected method 313, descriptive marker 314 and original IL code 315. This process will be explained in greater detail below.

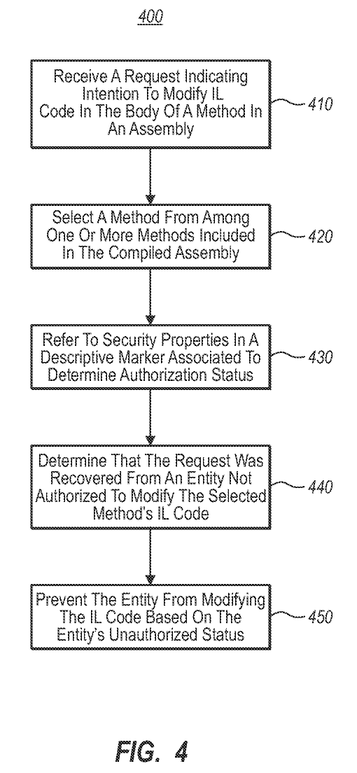

FIG. 4 illustrates a flowchart of a method 400 for modifying intermediate language (IL) code on a per-method basis for at least one method of the assembly. The method 400 will now be described with frequent reference to the components and data of environment 300.

Method 400 includes an act of receiving a request indicating an intention to modify IL code in the body of a method in an assembly (act 410). For example, method selection module may receive IL code modification 305 indicating user 350's intention to modify IL code 315 associated with selected method 313. In some cases, IL code modification 305 may be merely an indication that user 350 intends to modify selected method 313. In other cases, IL code modification 305 may be actual IL code intended by user 350 to replace or supplement IL code 315 in selected method 313. In other cases, IL code modification 305 may both indicate the user's intent to modify and provide the actual IL code to modify or replace IL code 315.

Method 400 includes an act of selecting a method from among one or more methods included in the compiled assembly, the methods being configured to perform one or more intended functions for an application (act 420). For example, method selection module 310 may select selected method 313 from methods 111 included in assembly 311. Methods 111 may be configured to perform various intended functions for a software application.

Method 400 includes an act of referring to security properties in a descriptive marker associated with the method indicating those entities that are authorized to modify the selected method's IL code (act 430). For example, modification module 320 may refer to security properties in descriptive marker 314 associated with selected method 313 indicating those entities that are authorized to modify IL code 315. In some cases, descriptive marker 314 indicates which users, computer systems, software applications or other entities are permitted to modify IL code 315. In some embodiments, entities indicated by descriptive marker 314 as authorized to modify IL code 315 without any kind of authentication. In other cases, modification module 320 may use authentication indication 326 to verify the user or other entity is who they say they are. For example, user 350 may send user credentials 306 to authentication module 325. Authentication module 325 may use any of a variety of techniques to verify the user or entity's credentials. Authentication module may then generate an authentication indication indicating that the entity is or is not authenticated and send the generated indication 326 to modification module 320. Moreover, in some embodiments, authentication module may be configured to authorize a code modification (e.g. IL code modification 305) based on the modification itself or on the modification's sender.

Method 400 also includes an act of determining that the received request was received from an entity that is not authorized to modify the selected method's IL code based on the security properties in the descriptive marker (act 440). For example, authentication module 325 may determine that IL code modification 305 was received from user 350 who, in at least in one example, is unauthorized to modify IL code 315 associated with selected method 313. Authentication module 325 may use any or a combination of authentication techniques to determine that user 350 is not authorized to modify IL code 315 or that IL code modification 305 came from someone other than user 350 (perhaps purporting to be user 350) who is not authorized to modify the code. In some cases, modification module 320 may send descriptive marker (and the accompanying security properties indicating authorized users) to authentication module 325 to determine whether the user is authorized. Additionally or alternatively, authentication module 325 may receive the security properties of descriptive marker 314 directly from method selection module 310.

Method 400 also includes, based on the determination, an act of preventing the entity from modifying the selected method's IL code based on the security properties in the descriptive marker (act 450). For example, based on the determination that IL code modification 305 was received from a user unauthorized to modify IL code 315, modification module 320 may prevent user 350 from modifying IL code 315 due to the user's unauthorized status. In such cases, assembly 311 with selected method 313, descriptive marker 314 and original IL code 315 may be output by modification module 320, or alternatively, nothing may be output. In other cases, where authentication module 325 indicates that IL code modification 305 was received from a user authorized to modify IL code 315, modification module 320 may modify IL code 315 according to the input IL code modification 305, resulting in assembly 331 with selected method 313, descriptive marker 314 and modified IL code 315A. In some cases, IL code modification 315 may entirely supplant any existing IL code in the selected method's body, or may merely supplement or modify portions of existing IL code in the selected method's body.

Thus, in some embodiments, IL code may be generated by an outside source and inserted into the method body of a selected method on a per-method basis. Furthermore, in some embodiments, IL code of a selected method may be modified by an IL code modification on a per-method basis. Those who are permitted to modify IL code within a selected method may be limited to those authorized in an appended descriptive marker and, optionally, who are authenticated using any of a variety of authentication means. Thus, IL code may be supplied or modified at runtime or any time the IL code is accessed.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. At a computer system including at least one binary file, a method for providing intermediate language (IL) code on a per-method basis for at least one method of the binary, the method comprising:
an act of selecting a method from among one or more methods included in a binary file, the one or more methods being configured to perform one or more intended functions for an application;
an act of appending a descriptive marker to the selected method indicating how to obtain IL code that is to be included in the body of the selected method;
an act of receiving a command to execute the selected method;
an act of referring to the appended descriptive marker to generate an IL code request based on the indication in the descriptive marker;
an act of submitting the generated IL code request to one or more IL code providers to request IL code for the selected method;
an act of receiving the requested IL code for the selected method; and
an act of inserting the IL code into the body of the selected method.

2. The method of claim 1, wherein the received IL code is received at any of the following stages: at runtime, as part of source compile, at post-processing of the binary file, as part of distribution, at deployment and at activation.

3. The method of claim 1, wherein the received IL code is used in conjunction with any existing IL code associated with the selected method.

4. The method of claim 1, wherein the descriptive marker indicates which entity is to provide the IL for the selected method using a software hook.

5. The method of claim 4, further comprising an act of providing an interface defining at least some of the functionality that a software hook writer is to provide in order to modify the IL code.

6. The method of claim 1, wherein the descriptive marker comprises a custom attribute.

7. The method of claim 1, wherein the descriptive marker further indicates which IL code generator is to be used to generate IL code for the selected method.

8. The method of claim 7, further comprising generating IL code using the indicated IL code generator.

9. The method of claim 7, wherein a plurality of different generators are used to generate IL code for different methods in the binary.

10. The method of claim 1, wherein the requested IL code is stored in a database.

11. The method of claim 10, wherein the stored IL code is encrypted.

12. The method of claim 1, further comprising an act of compiling the binary with the received IL code for the selected method.

13. The method of claim 1, wherein the selected method includes a plurality of descriptive markers.

14. The method of claim 1, wherein the plurality of descriptive markers are linked to each other.

15. At a computer system including at least one compiled assembly, a method for modifying intermediate language (IL) code on a per-method basis for at least one method of the assembly, the method comprising:
an act of receiving a request indicating an intention to modify IL code in the body of a method in an assembly;
an act of selecting a method from among one or more methods included in the compiled assembly, the methods being configured to perform one or more intended functions for an application;
an act of referring to security properties in a descriptive marker associated with the method indicating those entities that are authorized to modify the selected method's IL code;
an act of determining that the received request was received from an entity that is not authorized to modify the selected method's IL code based on the security properties in the descriptive marker; and
an act of preventing the entity from modifying the selected method's IL code based on the security properties in the descriptive marker.

16. The method of claim 15, further comprising:
an act of receiving another request indicating another entity's intention as to modify the IL code associated with the selected method; and
act of modifying the IL code associated with the selected method according to the received request based on a determination that the entity is authorized to modify the selected method's IL code.

17. The method of claim 15, further comprising an act of providing one or more means of authenticating the entity to verify the entity is authorized to modify the IL code associated with the selected method.

18. The method of claim 16, wherein the modified IL code replaces the body of the selected method.

19. A computer program product comprising one or more computer-readable media having thereon an application programming interface for providing intermediate language (IL) code on a per-method basis for at least one method of the binary, the application programming interface comprising computer-executable instructions that, when executed by one or more processors of the computing system, cause the computing system to perform a method, the method comprising:
an act of selecting a method from among one or more methods included in a binary file, the one or more methods being configured to perform one or more intended functions for an application;
an act of appending a descriptive marker to the selected method indicating how to obtain IL code that is to be included in the body of the selected method;
an act of receiving a command to execute the selected method;
an act of referring to the appended descriptive marker to generate an IL code request based on the indication in the descriptive marker;
an act of submitting the generated IL code request to one or more IL code providers to request IL code for the selected method;
an act of receiving the requested IL code for the selected method; and
an act of inserting the IL code into the body of the selected method.

20. The computer program product of claim 19, wherein the received IL code is received from at least one of a user and an IL code generator.
